(19) United States
(12) Patent Application Publication
(10) Pub. No.: US 2025/0374396 A1
(43) Pub. Date: Dec. 4, 2025

(54) Method for Configuring a Lamp for a Vehicle and Lamp for a Vehicle

(71) Applicant: ZKW Group GmbH, Wieselburg (AT)

(72) Inventor: Christian Guth, Mariasdorf (AT)

(21) Appl. No.: 19/197,119

(22) Filed: May 2, 2025

(30) Foreign Application Priority Data
May 29, 2024 (EP) 24178753.0

(51) Int. Cl. H05B 45/14; H05B 45/44

(52) U.S. Cl. CPC H05B 45/14; H05B 45/44

(57) ABSTRACT

A method for configuring a light for a vehicle, wherein the light has a light module including light sources, e.g., LEDs, arranged in a light string and a driver circuit for the electrical supply of the light module. The light module has at least one electronic auxiliary component (EAC) in the form of an ohmic resistor, which EAC is intended to be energized in a normal operation of the light module. The EAC has a resistance value representative of the brightness class of the light module. The method includes (a) providing a light module and a suitable driver circuit; (b) detecting the EAC resistance value of the light module; and (c) configuring the driver circuit as a function of the detected resistance value, so that the output voltage or the output current of the driver circuit is adjusted according to the brightness class of the light sources.

### CROSS-REFERENCE TO RELATED APPLICATIONS

This application claims priority to European Patent Application No. 24178753.0, filed May 29, 2024, which is incorporated herein by reference.

### TECHNICAL FIELD

The invention relates to a method for configuring a light for a vehicle, wherein the light has a light module comprising a number of light sources, in particular LEDs, and a driver circuit for the electrical supply of the light module, wherein the number of light sources are arranged in a light string.

### TECHNICAL BACKGROUND

In headlights and rear lights, simple LED PCBs are usually operated by light control devices or control boards. Due to different light source brightness classes, a binning resistor is usually also installed on the LED PCB or on a light module in order to identify the brightness class in question.

It would be desirable to create a solution that enables the brightness class to be recognized and also reduces the cabling and electronics required for this.

### SUMMARY OF THE INVENTION

This object is achieved by a method of the type mentioned at the beginning, wherein according to the invention the light module has at least one electronic auxiliary component in the form of an ohmic resistor, which auxiliary component is intended to be energized in normal operation of the light module, wherein this electronic auxiliary component has a resistance value which is representative of the brightness class of the light module, in particular of the light sources of the light module, wherein the method comprises the following steps: a) providing a light module and a suitable driver circuit, b) detecting the resistance value of the auxiliary component of the light module, c) configuring the driver circuit depending on the resistance value detected in step b), so that the output voltage or the output current of the driver circuit is adapted according to the brightness class of the light sources.

The number of light sources is typically two or more per strand. Several strands can also be provided. In principle, however, it is also conceivable that only a single light source per strand and/or only a single strand is provided. "Normal operation" of a light source is defined as operation in which the light source emits light and the current is typically within the nominal range of the light source. With regard to the resistance values of the auxiliary components of the lighting modules, tables can be provided in which an assignment of the resistance values to different brightness classes, in particular a bijective assignment, can be stored. The driver circuit can then be configured by comparing it with the table, which allows the existing brightness class to be inferred. Each brightness class is typically assigned its own resistance value.

In particular, it may be provided that in or after step b) or c) the driver circuit is connected to the light module for the electrical supply of the light module.

Furthermore, it may be provided that step c) takes place during the production of the light or the first commissioning of the light. For this purpose - as long as the driver circuit has not yet been configured according to the brightness class - it is possible to assume gentle operation with a low output power and then - after detection - to carry out the configuration and switch to normal operation.

Alternatively, the measuring current can also be higher than the rated current.

In particular, steps b) and c) can be carried out only once during the production or initial commissioning of the light and the configuration of the light module is then permanently maintained. This allows the system to "start up" more quickly once the configuration has been carried out. For this purpose, the configuration can be stored in a memory.

Furthermore, it may be provided that the driver circuit has a microcontroller to which the resistance value detected in step b) is fed, wherein the microcontroller is set up to control the output voltage/output current of the driver circuit as a function of the detected brightness class. In contrast to the prior art, the microcontroller does not detect the resistance value itself, but this resistance value is fed to the microcontroller.

In particular, it may be provided that the driver circuit has a constant voltage converter and a linear regulator, wherein the linear regulator is provided for readjusting the current in the light string, with the auxiliary component being connected in series with the light string. The linear regulator does not regulate the output voltage, but the current in the light string, i.e. the linear regulator acts as a constant current sink in the light string and the available voltage is specified by the constant voltage converter.

Furthermore, it may be provided that the auxiliary component has a resistance value which is selected such that in normal operation of the lighting module the electrical power which is converted at the auxiliary component is less than 10% of the power of the lighting string, wherein the resistance value of the auxiliary component is preferably between 0.1 ohm and 5 ohms, in particular between 0.5 ohms and 1.5 ohms. Typical currents through the light sources, especially in the form of LEDs, are ≤ 100 mA.

In particular, it may be provided that the resistance value of the auxiliary component of the light module is detected according to step b) during the production of the light by establishing an electrical connection between the light module and the driver circuit, temporarily short-circuiting the light string, preferably using a needle adapter, and driving a constant current via the auxiliary component by means of the driver circuit, wherein the resistance value of the auxiliary component and thus the brightness class of the light sources in the light string is inferred by simultaneously measuring the voltage at the auxiliary component.

Furthermore, it may be provided that the auxiliary component is connected in parallel to the light string in order to more quickly reduce an electrical voltage that may still be temporarily applied to the light string due to capacitive effects despite a desired switch-off of the driver circuit.

In particular, it may be provided that the driver circuit has at least two channels, wherein the auxiliary component is routed from a first node common to the light string to a first channel, and wherein the light string is routed from the first node to a second channel, a second node being provided on the first channel, wherein an additional electronic component in the form of an ohmic resistor, hereinafter referred to as additional resistor, is provided between the second node and the second channel, so that in the case of high-impedance operation of the first channel there is essentially a series circuit between the auxiliary component and the additional resistor, and this series circuit is connected in parallel with the light string.

Furthermore, it can be provided that the resistance value of the additional resistor is between 10 kOhm and 30 kOhm and the resistance value of the auxiliary component is between 1 and 5 Ohm.

In particular, it may be provided that the resistance value of the auxiliary component of the light module is detected in accordance with step b), wherein the first channel is activated and a reference current is conducted via the auxiliary component and the additional resistor to the second channel, wherein the differential voltage between the two channels and the potential at the first node are detected and the resistance value of the auxiliary component is inferred by measuring variables derived therefrom. This is particularly important when the light is used as a rear light.

It can also be provided that the first channel is operated with high impedance during normal operation of the light. This means that the channel is switched to a high impedance in order to keep incoming currents low and thus minimize electrical losses.

In particular, it may be provided that the light comprises two or more strings, each having light sources, wherein the light sources of the strings have the same brightness class, wherein each string is assigned its own channel, wherein the detection of the brightness class is carried out using a method according to the invention.

Furthermore, the invention relates to a configured light, wherein the light has a light module comprising a number of light sources, in particular LEDs, as well as a driver circuit for the electrical supply of the light module, wherein the number of light sources are arranged in a light string, wherein the light module has at least one electronic auxiliary component in the form of an ohmic resistor, which auxiliary component is intended to be energized in a normal operation of the light module, wherein this electronic auxiliary component has a resistance value which is representative of the brightness class of the light module, in particular of the light sources of the light module, wherein the configuration of the light was obtained by applying a method according to the invention.

### BRIEF DESCRIPTION OF THE DRAWINGS

The invention is explained in more detail below with reference to an exemplary and non-limiting embodiment, which is illustrated in the figures.

FIG. 1 is an equivalent circuit diagram of a light according to the prior art.

FIG. 2 is an equivalent circuit diagram of a light according to the invention in a first embodiment.

FIG. 3 is an equivalent circuit diagram of a light according to the invention in a second embodiment.

FIG. 4 is an equivalent circuit diagram of a light according to the invention analogous to FIG. 3, but with two light strands of the same brightness class.

FIG. 5 is an equivalent circuit diagram of a light according to the invention analogous to FIG. 3, but with two light strands of different brightness classes.

FIG. 6 is an equivalent circuit diagram of a typical driver circuit for supplying a light string.

### DETAILED DESCRIPTION OF EMBODIMENTS

In the following figures, the same reference symbols denote the same features, unless otherwise stated.

FIG. 1 shows an equivalent circuit diagram of a light according to the prior art. There is an individual resistance value Rh on a light module 2 in the form of an LED PCB, which individual resistance value Rh represents the brightness class of the installed LEDs. A microcontroller 3a on the control board or driver circuit 3 reads the voltage value resulting from Rp and Rh at an ADC pin and sets the current according to a table stored in the microcontroller 3a. The auxiliary resistor Rh is not energized in normal operation and is therefore only intended for classifying the brightness class. To prevent unwanted glimming, for example, an additional resistor must be provided.

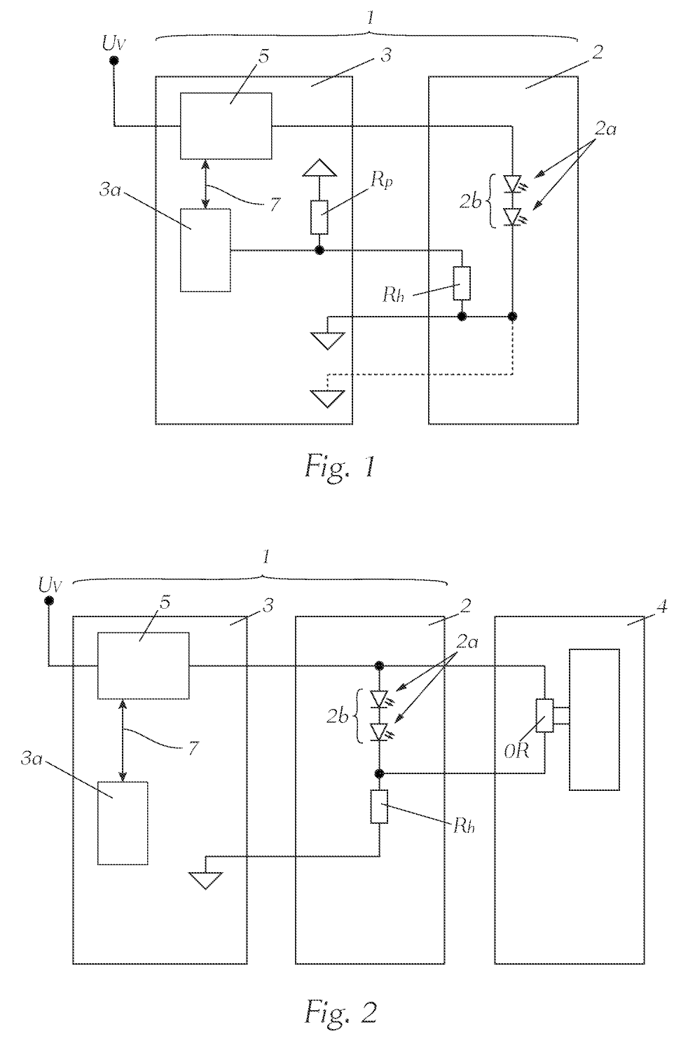

With reference to FIG. 2, a first embodiment of the invention is now discussed, which has many features in common with the remaining embodiments. Thus, all embodiments according to the invention have in common that they enable a method for configuring a light 1 for a vehicle, wherein the light 1 has a light module 2 comprising a number of light sources 2a, in particular LEDs, and a driver circuit 3 for the electrical supply of the light module 2. The light sources 2a are arranged in at least one light string 2b. In contrast to the prior art, the light module 2 has at least one electronic auxiliary component Rh in the form of an ohmic resistor, which auxiliary component Rh is intended to be energized even in normal operation of the light module 2, this electronic auxiliary component Rh having a resistance value which is representative of the brightness class of the light module 2, in particular of the light sources of the light module, the method comprising the following steps: a) providing a light module 2 and a suitable driver circuit 3, b) detecting the resistance value of the auxiliary component Rh of the light module 2, and c) configuring the driver circuit 3 as a function of the resistance value detected in step b, so that the output voltage or the output current of the driver circuit 3 is adapted in accordance with the brightness class of the light sources 2a. The driver circuit comprises a DC/DC converter 5, which is supplied by the supply voltage Uv. The reference sign 7 refers to a communication bus, e.g., SPI or UART.

In particular, it may be provided that in or after step b) or c) the driver circuit 3 is connected to the light module 2 for the electrical supply of the light module 2. Step c) can take place, for example, during the production of lights 1 or the initial commissioning of lights 1. In particular, steps b) and c) can be carried out only once during the production or initial commissioning of the light 1 and the configuration of the light module 2 is then permanently maintained. This allows the light 1 to be "started up" quickly once the configuration has been made. For this purpose, the light 1 can have a memory in which the configuration is stored.

Furthermore, it may be provided that the driver circuit 3 has a microcontroller 3a to which the resistance value detected in step b) is fed, wherein the microcontroller 3a is set up to control the output voltage/output current of the driver circuit 3 as a function of the detected brightness class.

With regard to FIG. 2, it should be mentioned that it may be provided in particular that the driver circuit 3 has a constant-voltage converter and a linear regulator, with the linear regulator being provided for readjusting the current in the light string 2b, with the auxiliary component Rh being connected in series with the light string 2b. It may be provided that the auxiliary component Rh has a resistance value which is selected such that in normal operation of the light module 2 the electrical power which is converted at the auxiliary component Rh is less than 10% of the power of the light string 2b, the resistance value of the auxiliary component Rh preferably being between 0.1 ohm and 5 ohms, in particular between 0.5 ohms and 1.5 ohms. Furthermore, it may be provided that the resistance value of the auxiliary component Rh of the light module 2 is detected according to step b) during the production of the light 1 by establishing an electrical connection between the light module 2 and the driver circuit 3, temporarily short-circuiting the light string 2b, preferably using a needle adapter 4, and a constant current is driven via the auxiliary component Rh by means of the driver circuit 3, wherein the simultaneous measurement of the voltage at the auxiliary component Rh is used to infer its resistance value and thus the brightness class of the light sources 2a in the light string 2b.

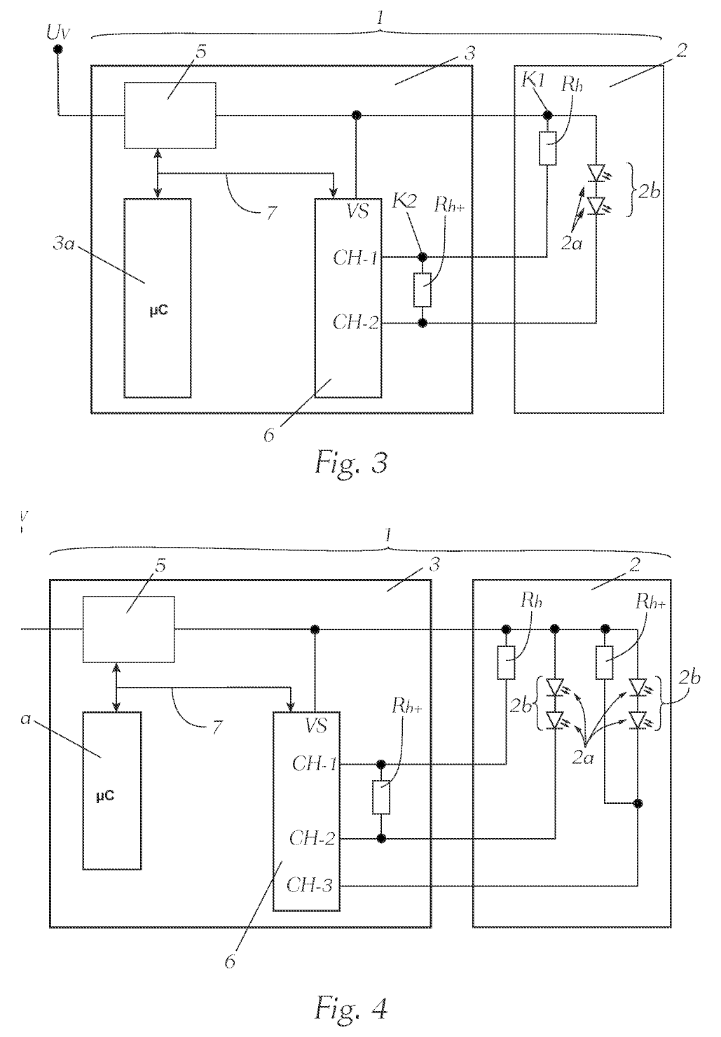

With regard to FIG. 3, it should be mentioned that, as an alternative to FIG. 2, the auxiliary component Rh can be connected in parallel to the light string 2b in order to more quickly reduce an electrical voltage that may still be temporarily present on the light string 2b due to capacitive effects despite the desired deactivation of the driver circuit 3. This can reduce unwanted afterglow from light sources 2a.

Furthermore, it may be provided that the driver circuit 3 has at least two channels CH1, CH2, wherein the auxiliary component Rh is routed from a first node K1 common to the light string 2b to a first channel CH1, and wherein the light string 2b is routed from the first node K1 to a second channel CH2, wherein a second node K2 is provided on the first channel CH1, wherein an additional electronic component in the form of an ohmic resistor, hereinafter referred to as additional resistor Rh+, is provided between the second node K2 and the second channel CH2, so that in the case of high-impedance operation of the first channel CH1 there is substantially a series circuit between the auxiliary component Rh and the additional resistor Rh+, and this series circuit is connected in parallel with the light string 2b. If Rh+ is used as an anti-glow resistor, it can additionally dissipate energy from residual capacitance or leakage currents during operation, which would otherwise lead to undesirable afterglow. Preferably, the resistance value of the additional resistor Rh+ can be between 10 kOhm and 30 kOhm and the resistance value of the auxiliary component Rh can be between 1 and 5 Ohm.

In particular, it may be provided that the resistance value of the auxiliary component Rh of the light module 2 is detected in accordance with step b) by activating the first channel CH1 and conducting a reference current via the auxiliary component Rh and the additional resistor Rh+ to the second channel CH2, wherein the differential voltage Uch12 between the two channels CH1, CH2 and the potential at the first node K1 are detected and the resistance value of the auxiliary component Rh is inferred by measuring variables derived therefrom. The potential can be measured in relation to CH2, for example. To save energy, the first channel CH1 can be operated with high impedance during normal operation of the light 1.

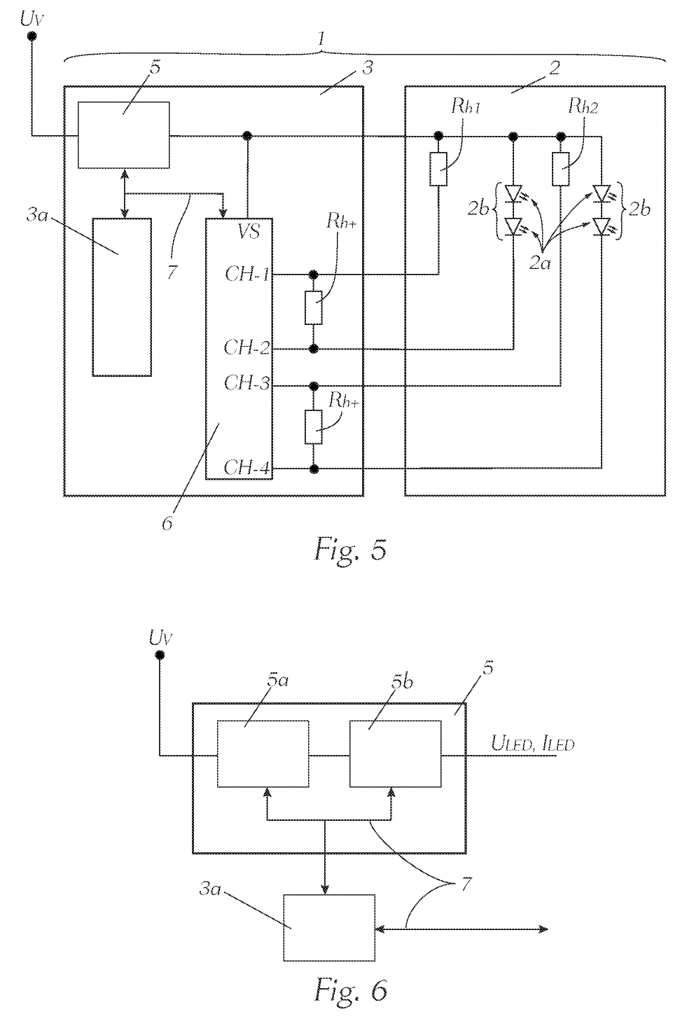

With reference to FIGS. 4 and 5, it should be mentioned that it may also be provided that the light 1 comprises two or more strings 2b, each of which has light sources 2a, the light sources 2a of the strings 2b having the same brightness class, each string 2b being assigned its own channel CH-4, CH-2, the detection of the brightness class being carried out using a method according to the invention.

In FIG. 4, the light strands 2b and their light sources 2a have the same brightness class. In FIG. 5, however, there are different brightness classes, which is why different auxiliary resistors Rh1 and Rh2 are provided.

FIG. 6 shows an equivalent circuit diagram of a typical DCDC converter for supplying a light module 2. The reference symbol 5a denotes a boost converter and the reference symbol 5b denotes a buck converter.

The invention also relates to a configured light 1, wherein the light 1 has a light module 2 comprising a number of light sources 2a, in particular LEDs, and a driver circuit 3 for the electrical supply of the light module 2, wherein the number of light sources 2a are arranged in a light string 2b, wherein the light module 2 has at least one electronic auxiliary component Rh in the form of an ohmic resistor, which auxiliary component Rh is intended to be energized in a normal operation of the light module 2, this auxiliary electronic component Rh having a resistance value which is representative of the brightness class of the light module 2, in particular of the light sources of the light module, the configuration of the light 1 having been obtained by applying a method according to the invention.

The invention is not limited to the embodiments shown, but is defined by the entire scope of protection of the claims. Individual aspects of the invention or the embodiments can also be taken up and combined with one another. In particular, all features of the method can be implemented in the device or those features of the method that are reflected in the implementation of the device can also be part of the device. Any reference signs in the claims are exemplary and serve only to make the claims easier to read without restricting them.

1. A method for configuring a light (1) for a vehicle, wherein the light (1) has a light module (2) comprising a number of light sources (2a), in particular LEDs, as well as a driver circuit (3) for the electrical supply of the light module (2), wherein the number of light sources (2a) are arranged in a light string (2b), wherein the light module (2) has at least one electronic auxiliary component (Rh) in the form of an ohmic resistor, which auxiliary component (Rh) is intended to be energized in a normal operation of the light module (2), this auxiliary electronic component (Rh) having a resistance value which is representative of the brightness class of the light module (2), in particular of the light sources of the light module, the method comprising the following steps:
a) providing a light module (2) and a suitable driver circuit (3);
b) detecting the resistance value of the auxiliary component (Rh) of the light module (2); and
c) configuring the driver circuit (3) as a function of the resistance value detected in step b), so that the output voltage or the output current of the driver circuit (3) is adjusted according to the brightness class of the light sources (2a).

2. The method according to claim 1, wherein in or after step b) or c) the driver circuit (3) is connected to the light module (2) for the electrical supply of the light module (2).

3. The method according to claim 1, wherein step c) takes place during the manufacture of the light (1) or the first commissioning of the light (1).

4. The method according to claim 3, wherein steps b) and c) are carried out only once during the production or first commissioning of the light (1) and the configuration of the light module (2) is then permanently maintained.

5. The method according to claim 1, wherein the driver circuit (3) comprises a microcontroller (3a) to which the resistance value detected in step b) is supplied,wherein the microcontroller (3a) is arranged to control the output voltage/current of the driver circuit (3) as a function of the detected brightness class.

6. The method according to claim 1, wherein the driver circuit (3) has a constant-voltage converter and a linear regulator, wherein the linear regulator is provided for readjusting the current in the light string (2b), wherein the auxiliary component (Rh) is connected in series with the light string (2b).

7. The method according to claim 6, wherein the auxiliary component (Rh) has a resistance value which is selected such that in normal operation of the light module (2) the electrical power which is converted at the auxiliary component (Rh) is less than 10% of the power of the light string (2b), wherein the resistance value of the auxiliary component (Rh) is preferably between 0.1 Ohm and 5 Ohm, in particular between 0.5 Ohm and 1.5 Ohm.

8. The method according to claim 6, wherein the detection of the resistance value of the auxiliary component (Rh) of the light module (2) according to step b) is carried out during the production of the light (1) by establishing an electrical connection between the light module (2) and the driver circuit (3), temporarily short-circuiting the light string (2b) preferably using a needle adapter (4), and a constant current is driven via the auxiliary component (Rh) by means of the driver circuit (3), wherein simultaneous measurement of the voltage at the auxiliary component (Rh) is used to infer its resistance value and thus the brightness class of the light sources (2a) in the light string (2b).

9. The method according to claim 1, wherein the auxiliary component (Rh) is connected in parallel with the light string (2b) in order to more rapidly reduce an electrical voltage which may still be temporarily present at the light string (2b) due to capacitive effects despite a desired switch-off of the driver circuit (3).

10. The method according to claim 1, wherein the driver circuit (3) has at least two channels (CH1, CH2), wherein the auxiliary component (Rh) is routed to a first channel (CH 1) starting from a first node (K1) common to the light string (2b), and wherein the light string (2b) is routed to a second channel (CH2) starting from the first node (K1),wherein a second node (K2) is provided on the first channel (CH 1), an additional electronic component in the form of an ohmic resistor, hereinafter referred to as additional resistor (Rh+), being provided between the second node (K2) and the second channel (CH2), so that in the case of high-impedance operation of the first channel (CH1) there is essentially a series circuit between the auxiliary component (Rh) and the additional resistor (Rh+), and this series circuit is connected in parallel with the light string (2b).

11. The method according to claim 10, wherein the resistance value of the additional resistor (Rh+) is between 10 kOhm and 30 kOhm and the resistance value of the auxiliary component (Rh) is between 1 and 5 Ohm.

12. The method according to claim 10, wherein the resistance value of the auxiliary component (Rh) of the light module (2) is detected according to step b) by activating the first channel (CH1) and conducting a reference current via the auxiliary component (Rh) and the additional resistor (Rh+) to the second channel (CH2), the differential voltage (Uch12) between the two channels (CH1, CH2) and the potential at the first node (K1) being detected and the resistance value of the auxiliary component (Rh) being inferred by measuring variables derived therefrom.

13. The method according to claim 10, wherein the first channel (CH1) is operated with high impedance during normal operation of the light (1).

14. The method according to claim 1, wherein the luminaire (1) comprises two or more strings (2b) each having light sources (2a), wherein the light sources (2a) of the strings (2b) have the same brightness class, wherein each string (2b) is assigned its own channel (CH-4, CH-2), wherein the detection of the brightness class is carried out using a method according to any of the preceding claims.

15. A configured light (1), wherein the light (1) has a light module (2) comprising a number of light sources (2a), in particular LEDs, and a driver circuit (3) for the electrical supply of the light module (2), wherein the number of light sources (2a) are arranged in a light string (2b), wherein the light module (2) has at least one electronic auxiliary component (Rh) in the form of an ohmic resistor, which auxiliary component (Rh) is intended to be energized in a normal operation of the light module (2), this auxiliary electronic component (Rh) having a resistance value which is representative of the brightness class of the light module (2), in particular of the light sources of the light module, the configuration of the light (1) having been obtained by applying a method according to claim 1.
